(19) United States
(12) Patent Application Publication
(10) Pub. No.: US 2008/0168206 A1
(43) Pub. Date: Jul. 10, 2008

(54) Methods and Apparatus for Interfacing a Processor and a Memory

(76) Inventors: Mark David Bellows, Rochester, MN (US); Paul Allen Ganfield, Rochester, MN (US); Kent Harold Haselhorst, Byron, MN (US); Ryan Abel Heckendorf, Rochester, MN (US); Ibrahim Abdel-Rahman Ouda, Rochester, MN (US); Tolga Ozguner, Rochester, MN (US)

Correspondence Address: IBM CORPORATION, INTELLECTUAL PROPERTY LAW, DEPT 917, 3605 HIGHWAY 52 NORTH, ROCHESTER, MN, 55901-7829, US

(21) Appl. No.: 11/620,110

(22) Filed: Jan. 5, 2007

(51) Int. Cl. G06F 13/14

(52) U.S. Cl. 710/305

(57) ABSTRACT

In a first aspect, a first method of interfacing a processor and memory is provided. The first method includes the steps of (1) providing a computer system including (a) a first memory; (b) a processor adapted to issue a functional command to the first memory; (c) a translation chip; (d) a cache memory coupled to the translation chip; (e) a first link adapted to couple the processor to the translation chip; and (f) a second link adapted to couple the translation chip to the first memory; and (2) calibrating the first link to transmit data between the processor and cache memory. Numerous other aspects are provided.

### FIELD OF THE INVENTION

The present invention relates generally to computer systems, and more particularly to methods and apparatus for interfacing a processor and a memory.

### BACKGROUND

A conventional computer system may include a processor coupled to an extreme data rate (XDR) memory via a memory interface, such as an XIO link. The XIO link may be a fast, narrow link (e.g., 72 bits wide) that consumes fewer pins on a processor coupled thereto than another conventional memory interface (e.g., a dual data rate (DDR) link). Consequently, the XIO link may enable a size of the processor and cost associated therewith to be reduced. However, XDR memory is more expensive and has less storage capacity than other memory (e.g., DDR memory). Accordingly, improved methods, apparatus and systems for interfacing a memory and a processor are desired.

### SUMMARY OF THE INVENTION

In a first aspect of the invention, a first method of interfacing a processor and memory is provided. The first method includes the steps of (1) providing a computer system including (a) a first memory; (b) a processor adapted to issue a functional command to the first memory; (c) a translation chip; (d) a cache memory coupled to the translation chip; (e) a first link adapted to couple the processor to the translation chip; and (f) a second link adapted to couple the translation chip to the first memory; and (2) calibrating the first link to transmit data between the processor and cache memory.

In a second aspect of the invention, a first apparatus for interfacing a processor and memory of a computer system is provided. The first apparatus includes (1) a processor adapted to issue a functional command to a first memory; (2) a translation chip; (3) a cache memory coupled to the translation chip; (4) a first link adapted to couple the processor to the translation chip; and (5) a second link adapted to couple the translation chip to the first memory. The apparatus is adapted to calibrate the first link to transmit data between the processor and cache memory.

In a third aspect of the invention, a first system for interfacing a processor and a memory of a computer system is provided. The first system includes (1) a first memory; (2) a processor adapted to issue a functional command to the first memory; (3) a translation chip; (4) a cache memory coupled to the translation chip; (5) a first link adapted to couple the processor to the translation chip; and (6) a second link adapted to couple the translation chip to the first memory. The system is adapted to calibrate the first link to transmit data between the processor and cache memory. Numerous other aspects are provided in accordance with these and other aspects of the invention.

Other features and aspects of the present invention will become more fully apparent from the following detailed description, the appended claims and the accompanying drawings.

### BRIEF DESCRIPTION OF THE FIGURES

FIG. 1 is a block diagram of a system for interfacing a memory and a processor in accordance with an embodiment of the present invention.

FIG. 2 illustrates a method for interfacing a memory and a processor in accordance with an embodiment of the present invention.

### DETAILED DESCRIPTION

The present invention provides improved methods, apparatus and systems for interfacing a memory and a processor. For example, the present invention may provide a translation chip that couples a processor to a DDR memory (e.g., SDRAM) of a computer system. More specifically, the computer system may include an XIO link that couples the processor to the translation chip. Further, the computer system may include a DDR link that couples the translation chip to the DDR memory. DDR memory is cheaper than other memory, such as the XDR memory, and/or has a higher storage capacity than such other memory. However, the DDR link may be slower than other links (e.g., the XIO link). Therefore, a width of the DDR link may be increased (e.g., to 288 bits) such that the bandwidth of the DDR link may be increased to match that of the XDR link. The translation chip may be adapted to convert an XDR memory command issued by the processor to a DDR memory command which may be received by the DDR memory. By coupling an XIO link to the processor, the present methods, apparatus and systems may reduce a size of the processor and cost associated therewith. Further, by employing DDR memory, the present methods, apparatus and systems may employ an inexpensive memory having a high storage capacity (compared to other types of memory).

The present invention may calibrate the XIO link such that the processor may successfully read data from, write data to, and/or refresh the DDR memory. For example, the translation chip may include a cache memory. To calibrate the XIO link, data may be written to the cache memory. Thereafter, to ensure the processor may properly receive data from the cache memory, the processor may employ the XIO link to read data from the cache memory. The processor may receive and check the data read from the cache memory. To check the data, the processor may compare the received data read from the cache memory with expected data which may be provided by a memory interface controller of the processor. If the received data does not match the expected data, the processor may repeat the above-described process. However, when repeating the process, the processor may adjust a time when the data read from the cache memory is received by the processor such that the processor may successfully read the data from the cache memory via the XIO link.

Further, to ensure the processor may properly transmit data to the cache memory, the processor may write data to the cache memory during a first time period. Thereafter, the processor may read such data from the cache memory and compare the data to expected data. If the data read from the cache memory and received by the processor does not match the expected data, the data write to the cache memory was unsuccessful. Consequently, the processor may repeat the above-described process. However, when repeating the process, the processor may adjust a time when the data is written to the cache memory such that data may be successfully written to the cache memory via the XIO link. In this manner, the XIO link may be trained to read data from, and/or write data to the cache memory.

As stated, the translation chip may be coupled to the processor via the XIO link, and the cache memory may be included in the translation chip. Therefore, the cache memory may be approximately the same distance from the processor as XDR memory is from the processor of the conventional computer system. Consequently, a latency associated with the path between the cache memory and processor may be approximately the same as that associated with the path between the XDR memory and processor of the computer system. Thus, the processor of the present invention may not have to be redesigned (compared to a conventional processor) to calibrate the XIO link.

Once the XIO link is calibrated to read data from, and/or write data to the cache memory, such link may easily be calibrated to perform functional operations on memory coupled to the processor via the translation chip, such as the DDR memory. More specifically, the path between the translation chip and DDR memory may introduce command latency. Therefore, the processor may be reprogrammed to expect to see data received from the DDR memory at a later time, thereby accounting for such command latency.

In this manner, the present invention provides improved methods, apparatus and systems for interfacing a memory and processor. More specifically, the present invention may provide methods, apparatus and systems for calibrating an XIO link employed to interface a processor and a DDR memory.

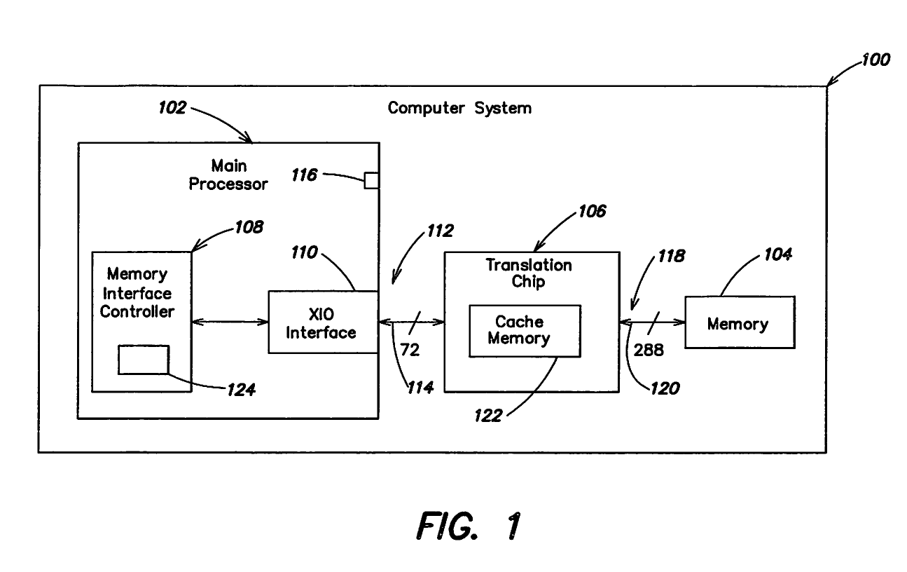

FIG. 1 is a block diagram of a system 100 for interfacing a memory and a processor in accordance with an embodiment of the present invention. With reference to FIG. 1, the system 100 may be a computer or similar device. The system 100 may include a processor 102 coupled to a first memory 104 via a translation chip 106. The processor 102 may be adapted to issue functional commands, such as a read, write and/or the like, to the memory 104. The commands issued by the processor 102 may be of a first type. The translation chip 106 may be adapted to receive a command of the first type, translate such command to a command of a second type and forward the command of the second type to the memory 104. More specifically, the processor 102 may include and/or be coupled to a memory interface controller (MIC) 108 adapted to control the flow of data to and from the memory 104. The MIC 108 may be coupled to a memory interface 110. The memory interface 110 may be included in and/or coupled to the processor 102. The memory interface 110 may be an extreme input/output (XIO) interface. Typically, a processor employs an XIO interface to couple directly to an XDR memory, architected by Rambus, Inc. of Los Altos, Calif. However, because XDR memory is expensive and has less storage capacity than other memories, the present system 100 may employ a different type of memory 104. For example, the memory 104 may be a dual data rate (DDR) memory (e.g., a DDR2 or DDR3 memory), which may be less expensive and/or have more storage capacity than XDR memory.

However, the memory interface 110 may not be adapted to couple directly to the DDR memory 104. Therefore, the memory interface 110 may be coupled, via a first link 112, to the translation chip 106, which may translate a command of a first type received from the processor 102 to a command of a different type which may be received by the memory 104. The first link 112 may be a narrow, fast link such as an XIO link. An XIO link may provide high bandwidth to memory by enabling eight bits of data to be sent on each of a plurality of lines in the link per clock cycle from the MIC 108 to the translation chip 106. Consequently, the XIO link may be capable of achieving signal rates of at least 3.2 Gbps, which may allow the MIC 108 and/or processor 102 coupled thereto to use fewer I/O, and therefore, save on die size and cost. More specifically, in some embodiments, the first link 112 may include a 72-bit bus 114. However, the bus 114 may be wider or narrower. Further, the first link 112 may include a larger number of and/or different types of buses. The bus 114 may be adapted to transmit read, write, refresh and/or similar commands thereon. Because the first link 112 is fast and narrow, a reduced number of processor pins 116 may be required to couple to the link 112. For example, seventy-two processor pins 116 may be required to couple to the bus 114 (although a larger or smaller number of pins may be required). Consequently, an overall number of pins 116 included in the processor 102 may be reduced (compared to the number of pins required to couple a different type of link). Therefore, a size of the processor 102 and cost associated therewith may be reduced.

Thus, the translation chip 106 may couple to a processor 102, which executes an application requiring access to a large amount of memory, via an XIO interface and XIO link. The translation chip 106 may receive XDR command and data protocols and convert such command and data protocol to DDR 2 or DDR 3 command and data protocols. By coupling an XIO link to a DDR memory, the translation logic 106 provides the system 100 with the advantage of using the XIO link (e.g., fewer pins consumed on an expensive processor 102) and the advantage of using DDR memory (e.g., lower cost and higher storage capacity than other memories).

As described in detail below, the translation chip 106 may receive the command of the first type from the processor 102 via the first link 112 and convert such command to a command of the second type. Further, the translation chip 106 may be coupled to the memory 104 via a second link 118. The second link may be a link that is slower than the first, such as a DDR link. However, the second link 118 may be wider than the first link 112 (e.g., so the bandwidth of the second link 118 matches that of the first). For example, the second link 118 may include a 288-bit bus 120. However, the bus 120 may be wider or narrower as long as the second link 118 is wider than the first link 112 (if the second link 118 is slower). Further, the second link 118 may include a larger or smaller number of and/or different types of buses. The bus 120 may be adapted to transmit commands of the second type and an address and/or data associated therewith to the memory 104. Therefore, the translation chip 106 may be adapted to receive data bits from a 72-bit bus 114 and transmit the data bits on a 288-bit bus 120. In this manner, the system 100 may employ the narrow, fast first link 112 to reduce a size and/or cost associated with the processor 102 coupled thereto. Further, the system 100 may employ an inexpensive memory 104 having a large storage capacity.

Before a computer system including a processor coupled directly to an extreme data rate (XDR) memory via an XIO link, may transmit data between the processor and memory, the XIO link should be calibrated. Calibration of the XIO link may include adjusting a time when data is received by the processor from the XDR memory via the XIO link such that data may successfully be read from the XDR memory. For example, a memory interface controller coupled to the processor may be employed to store data expected to be received from the memory (e.g., expects data) which corresponds to respective data that was previously transmitted to the memory. More specifically, the memory interface controller may employ a four entry queue to store expects data. A time when data is received by the processor may be adjusted such that the received data may be compared with the expected data corresponding thereto. Additionally, the calibration of the XIO link may include adjusting a time when data is transmitted from the processor to the XDR memory via the XIO link such that that data may subsequently be received by the processor (as part of an XDR memory read) and compared with the expected data corresponding thereto. In such system, the XDR memory may enable the data to be serially scanned therein via the XIO link. Further, the memory interface controller in such system is designed to calibrate the XDR link when a distance between the memory interface controller and XDR memory is of a low latency (e.g., when the XIO link directly couples the processor to the XDR memory). However, when a temporal distance between the memory and processor is not of a low latency (e.g., when the XIO link does not directly couple the processor to the XDR memory), such system may have difficulty calibrating the XIO link. Further, the XDR memory included in such system may be expensive and have a low storage capacity. Without further modification, if such processor, memory interface controller, and XIO link are employed to couple to the translation chip 106 in the above-described system 100, the system 100 may be unable to directly scan data into the DDR memory 104. Additionally, without further modification, a latency added to the path between the processor 102 and first memory 104 by the translation chip 106 and second link 118 may prevent the system 100 from successfully calibrating the first link 112 (e.g., XIO link).

Therefore, the processor 102 of the system 100 may be modified (e.g., redesigned) to add latency to one or more data paths included therein and/or to include additional hardware adapted to store a larger number (e.g., twenty) of expects data entries such that the system 100 may account for the latency in the data path between the modified processor and the first memory 104 added by the translation chip 106 and second link 118 while calibrating the first link 112 (e.g., and maintaining full bandwidth). However, such a solution increases the size and complexity of the modified processor. Further, by requiring such a processor modification, the system 100 may be unable to support existing processors which are prevalent.

Consequently, the translation chip 106 may include a cache memory 122 that the processor 102 may write data to and/or read data from (e.g., during calibration of the first link 112). Thus, the cache memory 122 may directly be coupled to the processor 102 via the first link 112. The temporal distance of the cache memory 122 from the processor 102 (and MIC 108 coupled thereto) may be approximately the distance of the XDR memory from the processor in the above-described system in which a processor directly couples to an XDR memory via an XDR link. Therefore, the processor, MIC and first link of such system may be employed as the respective processor 102, MIC 108 and first link 112 of the system 100, which may transmit a command of a first type from the processor 102, convert the command of the first type to a command of a second type that may be received by the memory 104, and transmit the command of the second type to the memory 104. However, in contrast to the system including a processor directly coupled to the XDR memory via an XIO link, the system 100 may calibrate the first link 112 by transmitting data between the processor 102 and the cache memory 122 via the first link 112. For example, calibration of the first link 112 may include adjusting a time when data is received by the processor 102 from the cache memory 122 via the first link 112 such that data may successfully be read from the cache memory 122. For example, the MIC 108 may be employed to store data expected to be received from the cache memory 122 (e.g., expects data) which corresponds to respective data that was previously transmitted from the processor 102 to the cache memory 122. The above-described translation chip 106 may be I/O bound, so the calibration cache 122 is not a problem. More specifically, the translation chip 106 may be sized to accommodate the above-described I/O, so translation chip 106 may easily include the cache memory 122.

Because the temporal distance between the processor 102 and cache memory 122 is approximately the distance between a processor and XDR memory in the system which directly couples the processor to the XDR memory via an XIO link, the MIC 108 may include the same or a similar number of queue entries for storing expects data. Each entry may store 32 cachelines (e.g., 32×128 Bytes) of data. However, larger or smaller entries may be employed. Thus, the MIC 108 may not need to have a deeper queue for storing expects data corresponding to data employed during calibration of the system 100. For example, the MIC 108 may employ a four entry queue 124 to store expects data. A time when data is received by the processor 102 may be adjusted such that the received data may be compared with the expected data corresponding thereto. Additionally, the calibration of the first link 112 may include adjusting a time when data is transmitted from the processor 102 to the cache memory 122 via the first link 112 such that that data may subsequently be received by the processor 102 (as part of a cache memory read) and compared with the expected data corresponding thereto. In such system 102, the cache memory 122 may enable the data to be serially scanned therein via the first link 112. In this manner, the MIC 108 in such system 100 may be designed to calibrate the first link 112. By employing the cache memory 122 to calibrate the first link 112, the system 100 may not have to account for the latency in the data path between the processor 102 and the first memory 104 while calibrating the first link 112. Although timing of signals is described above, calibration of the first link may also include adjusting a strength of signals transmitted on the first link 112.

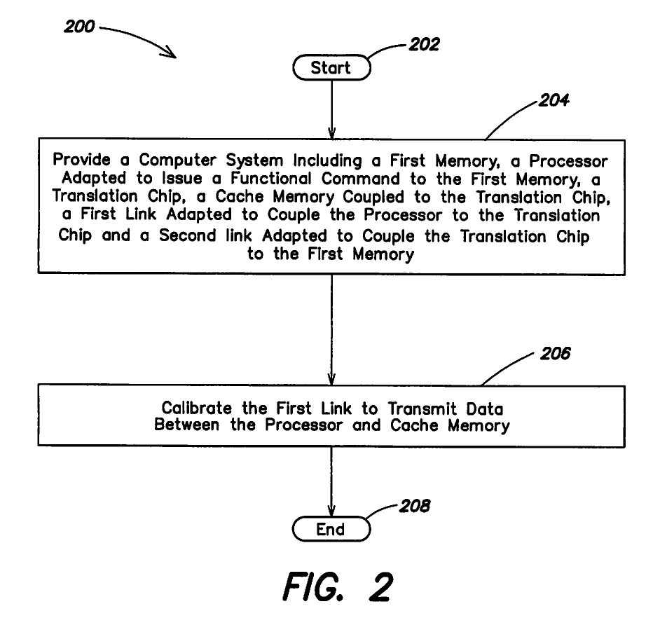

Operation of the system 100 is now described in detail with reference to FIG. 2 which illustrates a method for interfacing a memory and a processor in accordance with an embodiment of the present invention. With reference to FIG. 2, in step 202, the method 200 begins. In step 204, a computer system 100 including a first memory 104, a processor 102 adapted to issue a functional command to the first memory 104, a translation chip 106, a cache memory 122 coupled to the translation chip 106, a first link 112 adapted to couple the processor 102 to the translation chip 106 and a second link 118 adapted to couple the translation chip 106 to the first memory 104 may be provided. The processor 102 may be adapted to issue a command of a first type on the first link 112. The translation chip 106 may be adapted to receive the command of the first type, convert the command of the first type to a command of the second type and transmit the command of the second type to the first memory 104 via the second link 118. Therefore, the translation chip 106 may be used to couple existing processors (that are adapted to issue XDR commands on an XIO link) to a DDR memory, which may be cheaper than XDR memory. However, the translation chip 106 and second link 118 add latency to the path between the processor 102 and the first memory 104, such that the system 100 may not be able to calibrate the first link 112 by employing the processor 102 to write data to and/or read data from the first memory 104. Consequently, the translation chip 106 includes the cache memory 122 which may be employed by the system 100 while calibrating the first link 112.

In step 206, the first link 112 is calibrated to transmit data between the processor 102 and cache memory 122. The calibration may be a three-step timing calibration. For example, to calibrate the first link 112, data may be scanned into the cache memory 122. More specifically, the processor 102 may write data to the cache memory 122. The MIC 108 may store such data as expects data in entries of the queue 124. Thereafter, an initial receive calibration may be performed on the first link 112. During the initial receive calibration, the cache memory 122 may provide data to the processor 102. For example, the processor 102 may read data from the cache memory 122 that was previously scanned into the cache memory 122. To determine whether the processor 102 correctly reads the data from the cache memory 122, the processor 102 may compare the data received by the processor 102 as part of the cache memory read with expects data corresponding to the received data. As described above, the expects data may be stored in the MIC 108. If the processor 102 unsuccessfully reads the data, the processor 102 may repeat reading such data from the cache memory 122 until the data is successfully read. However, when repeating the above-described process, the processor 102 may adjust a time when data read from the cache memory 122 is received by the processor 102 until the processor 102 may successfully read the data from the cache memory 122. In this manner, during the receive calibration, the processor 102 may check the data and adjust a receive time of the data until the processor 102 may reliably receive the data. The above-described step may be performed for a plurality of pins 116 (e.g., each data pin) of the processor 102.

Further, an initial transmit calibration may be performed on the first link 112. During transmit calibration, the processor 102 may send data to and receive data from the cache memory 122. For example, as part of the transmit calibration, the processor 102 may transmit data into the cache memory 122. The processor 102 may attempt to read such data from the cache memory 122. To determine whether the processor 102 successfully reads such data from the cache memory 122, the processor 102 may compare the data received by the processor 102 as part of the cache memory read with expects data corresponding to the received data. If the processor 102 unsuccessfully reads the data, the processor 102 may repeat transmitting and attempting to read such data from the cache memory 122 until the data is successfully read. However, when repeating the above-described process, the processor 102 may adjust a time when such data is written to the cache memory 122 until the processor 102 may successfully read the data from the cache memory 122. In this manner, during the transmit calibration, the processor may adjust a time when data is sent to the cache memory 122 until the processor 102 may reliably receive such data from the cache memory 122. The above-described steps may be performed for a plurality of pins 116 (e.g., each pin) of the processor 102 such that each pin 122 may be calibrated to receive data and transmit data. Thus, during receive calibration, the cache memory 122 may provide data to the processor 102, and during transmit calibration, the cache memory 122 may receive calibration data from and transmit calibration data to the processor 102.

In this manner, the first link 112 may be calibrated by writing data to and/or reading data from the cache memory 122 of the translation chip 106. Because the temporal distance between the cache memory 122 and the processor 102 is approximately the same as the distance of an XDR memory from a processor in an XDR memory system including a processor directly coupled to an XDR memory via an XIO link, the processor and XIO link of the XDR memory system may serve as the processor 102 and the XIO link 112 in the present system 100. However, a different type of processor and/or first link may be employed. By employing a calibration data storing device (e.g., cache memory 122) that is closer to the processor 102 than the first memory 104, inputs and outputs (I/Os) to the processor MIC 108 may be calibrated in approximately the same time as I/Os between a processor and XDR memory in the XDR memory system.

Once the first link 112 is calibrated, the processor 102 may transmit a command of the first type (e.g., an XDR command) to the translation chip 106. The translation chip 106 may convert the command of the first type to a command of a second type (e.g., a DDR command). However, to ensure successful transfer of data between the processor 102 and the first memory 104 (e.g., a DDR memory), the second link 118 may be calibrated such that the translation chip 106 may successfully read data from and/or write data to the first memory 104. Additionally or alternatively, the processor 102 may be programmed to account for the latency in the path between the processor 102 and first memory 104 introduced by the translation chip 106 and second link 118. For example, due to such latency, data read from the first memory 104 may be received by the processor 102 later than data read from the cache memory 122. Therefore, once the I/Os between the processor 102 and translation chip 106 have been calibrated, the memory interface controller 108 may be programmed to receive data later because the real memory transactions will be going to and coming from the first memory (e.g., DDR DRAM) 104. For example, the memory interface controller 108 may be programmed to provide the expects data at a later time so that the expects data provided by the MIC 108 still corresponds to the data received by the processor 102 as part of the first memory read. In this manner, the path between the processor 102 and the first memory 104 may be calibrated such that data may successfully be transmitted between such components.

Thereafter, step 208 may be performed. In step 208, the method 200 ends. Through use of the method 200, a processor 102 and a first memory 104 of the system 100 may be interfaced with a translation chip 106. More specifically, the processor 102 may be coupled to the translation chip 106 via a first link 112 and the translation chip 106 may be coupled to the first memory 104 via a second link 118. The translation chip 106 may be adapted to receive commands of a first type from the processor 102, convert such command of the first type to a command of the second type and transmit the command of the second type to the first memory 104. Further, the path between the processor 102 and the first memory 104 may be calibrated. Such calibration may include calibration of the first link 112 by transmitting data between the processor 102 and a cache memory 122 within or coupled to the translation chip 106. Thus, the present invention may employ a device to store calibration data that is separate from the first memory 104 and is located in the translation chip 106. By moving the calibration data storage device to the translation chip 106, a duration of time between sending and receiving data may be shortened. Consequently, the calibration may occur at full speed. The second link 118 to the first memory 104 may be calibrated in a separate step to ensure that data may be transmitted successfully between the translation chip 106 and first memory 104. Additionally, the processor 102 may be programmed to account for latency in the path between the processor 102 and first memory 104 introduced by the translation chip 106 and second link 118 such that the data may successfully be transmitted between the processor 102 and first memory 104. Thus, the translation chip 106 may be calibrated to transmit data between the processor 102 and first memory 104.

The first link 112 may be adapted to reduce a size and/or cost associated with the processor coupled thereto. Additionally, the first memory 104 may be cheaper and/or have more storage capacity than other memories. Further, the cache memory 122 included in the translation chip 106 may make calibration of the path between the processor 102 and cache memory 122 similar to the calibration of an XIO link that directly couples a processor to an XDR memory in an XDR memory system. Therefore, the present system 100 may include (e.g., support) the processor and XIO link of the XDR system. Thus, the present invention may enable the processor 102 to be smaller (compared to processors in conventional systems), calibration to take less time, and support of existing hardware without modification.

The foregoing description discloses only exemplary embodiments of the invention. Modifications of the above disclosed apparatus and methods which fall within the scope of the invention will be readily apparent to those of ordinary skill in the art. For instance, although FIG. 1 illustrates the cache memory 122 as included in the translation chip 106, in some embodiments, the cache memory 122 may be external and coupled to the translation chip 106.

Accordingly, while the present invention has been disclosed in connection with exemplary embodiments thereof, it should be understood that other embodiments may fall within the spirit and scope of the invention, as defined by the following claims.

The invention claimed is:

1. A method of interfacing a processor and memory, comprising:
providing a computer system including:
a first memory;
a processor adapted to issue a functional command to the first memory;
a translation chip;
a cache memory coupled to the translation chip;
a first link adapted to couple the processor to the translation chip; and
a second link adapted to couple the translation chip to the first memory; and
calibrating the first link to transmit data between the processor and cache memory.

2. The method of claim 1 wherein calibrating the first link to transmit data between the processor and cache memory includes:
calibrating the processor such that data read from the cache memory is successfully received by the processor via the first link; and
calibrating the processor such that data transmitted from the processor via the first link may be successfully written to the cache memory.

3. The method of claim 2 wherein calibrating the processor such that data read from the cache memory is successfully received by the processor via the first link includes adjusting a time when data read from the cache memory is received by the processor such that the data read from the cache memory is successfully received by the processor via the first link.

4. The method of claim 2 wherein calibrating the processor such that data transmitted from the processor via the first link may be successfully written to the cache memory includes adjusting a time when the data is transmitted from the processor such that the data transmitted from the processor via the first link may be successfully written to the cache memory.

5. The method of claim 1 further comprising calibrating the processor to transmit data between the processor and the first memory.

6. The method of claim 5 wherein calibrating the processor to transmit data between the processor and the first memory includes calibrating the processor to receive data transmitted from the first memory later than that transmitted from the cache memory.

7. The method of claim 1 further comprising employing the translation chip to convert a memory command of a first type issued from the processor to a memory command of a second type received by the first memory.

8. The method of claim 1 wherein:
the first memory is a dual data rate (DDR) memory;
the first link is an extreme input/output (XIO) link; and
the second link is a DDR link.

9. An apparatus for interfacing a processor and memory of a computer system, comprising:
a processor adapted to issue a functional command to a first memory;
a translation chip;
a cache memory coupled to the translation chip;
a first link adapted to couple the processor to the translation chip; and
a second link adapted to couple the translation chip to the first memory;
wherein the apparatus is adapted to calibrate the first link to transmit data between the processor and cache memory.

10. The apparatus of claim 9 wherein the apparatus is further adapted to:
calibrate the processor such that data read from the cache memory is successfully received by the processor via the first link; and
calibrate the processor such that data transmitted from the processor via the first link may be successfully written to the cache memory.

11. The apparatus of claim 10 wherein the apparatus is further adapted to adjust a time when data read from the cache memory is received by the processor such that the data read from the cache memory is successfully received by the processor via the first link.

12. The apparatus of claim 10 wherein the apparatus is further adapted to adjust a time when the data is transmitted from the processor such that the data transmitted from the processor via the first link may be successfully written to the cache memory.

13. The apparatus of claim 9 wherein the apparatus is further adapted to calibrate the processor to transmit data between the processor and the first memory.

14. The apparatus of claim 13 wherein the apparatus is further adapted to calibrate the processor to receive data transmitted from the first memory later than that transmitted from the cache memory.

15. The apparatus of claim 9 wherein the apparatus is further adapted to employ the translation chip to convert a memory command of a first type issued from the processor to a memory command of a second type received by the first memory.

16. The apparatus of claim 9 wherein:
the first memory is a dual data rate (DDR) memory;
the first link is an extreme input/output (XIO) link; and
the second link is a DDR link.

17. A system for interfacing a processor and a memory of a computer system, comprising:
a first memory;
a processor adapted to issue a functional command to the first memory;
a translation chip;
a cache memory coupled to the translation chip;
a first link adapted to couple the processor to the translation chip; and
a second link adapted to couple the translation chip to the first memory;
wherein the system is adapted to calibrate the first link to transmit data between the processor and cache memory.

18. The system of claim 17 wherein the system is further adapted to:
calibrate the processor such that data read from the cache memory is successfully received by the processor via the first link; and
calibrate the processor such that data transmitted from the processor via the first link may be successfully written to the cache memory.

19. The system of claim 18 wherein the system is further adapted to adjust a time when the data read from the cache memory is received by the processor such that the data read from the cache memory is successfully received by the processor via the first link.

20. The system of claim 18 wherein the system is further adapted to adjust a time when the data is transmitted from the processor such that the data transmitted from the processor via the first link may be successfully written to the cache memory.

21. The system of claim 17 wherein the system is further adapted to calibrate the processor to transmit data between the processor and the first memory.

22. The system of claim 21 wherein the system is further adapted to calibrate the processor to receive data transmitted from the first memory later than that transmitted from the cache memory.

23. The system of claim 17 wherein the system is further adapted to employ the translation chip to convert a memory command of a first type issued from the processor to a memory command of a second type received by the first memory.

24. The system of claim 17:
the first memory is a dual data rate (DDR) memory;
the first link is an extreme input/output (XIO) link; and
the second link is a DDR link.
